(19) United States
(12) Patent Application Publication
(10) Pub. No.: US 2026/0188199 A1
(43) Pub. Date: Jul. 2, 2026

(54) DISPLAY FOR AUGMENTED REALITY HAVING A BRIGHTNESS MODE WITH SHIFTED COLORS

(71) Applicant: GOOGLE LLC, Mountain View, CA (US)

(72) Inventor: Aurelien Jean Francois David, San Francisco, CA (US)

(21) Appl. No.: 19/429,422

(22) Filed: Dec. 22, 2025

Related U.S. Application Data
(60) Provisional application No. 63/740,632, filed on Dec. 31, 2024.

(51) Int. Cl. G09G 3/32; G02B 27/01

(52) U.S. Cl. CPC G09G 3/32; G02B 27/0172; G02B 2027/0178; G09G 2320/0626; G09G 2320/0666; G09G 2360/144

(57) ABSTRACT

A display for a head-worn device includes a planar array of micro-light-emitting diodes (micro-LEDs), a sensor, and a driver. The driver is configured to operate the display in at least two modes. A first mode uses a first current density to produce a first brightness and a first range of colors. In response to the sensor detecting a high ambient light condition, the driver can switch the display to a second, high-brightness mode. In the second mode, the driver uses a second, higher current density to produce a second brightness greater than the first brightness. This increase in current density causes a predictable shift in the dominant wavelength of the micro-LEDs, resulting in a second range of colors that is different from the first. This intentional trade-off between color accuracy and brightness ensures that virtual content remains visible to a user in bright environments.

### CROSS REFERENCE TO RELATED APPLICATION

This application claims the benefit of U.S. Provisional Application No. 63/740,632, filed on December 31, 2024, which is hereby incorporated by reference in its entirety.

### BACKGROUND

A micro-light-emitting diode (micro-LED) display is a type of self-emissive display technology. Unlike liquid crystal displays (LCDs), which rely on a constant backlight that is modulated by liquid crystals and color filters, each pixel in a micro-LED display is composed of microscopic, individual light-emitting diodes that produce their own light. This architecture provides significant advantages over other technologies. Compared to organic light-emitting diode (OLED) displays, which are also self-emissive but use organic compounds, micro-LEDs are made from inorganic semiconductor materials. The use of the inorganic semiconductor materials, especially compound semiconductor materials, can offer substantially higher peak brightness, greater power efficiency, and a longer lifespan without susceptibility to burn-in. The small size, efficiency, and brightness of these displays can make them suitable for head-worn devices.

### SUMMARY

The technology described in this disclosure presents a display for a head-worn device that can be driven temporarily in a "boost mode" in which predictable and controlled shifts in color are accepted in exchange for a significant increase in overall brightness. This tradeoff ensures that virtual content remains clearly visible to a user while in a bright environment, such as direct sunlight.

In some aspects, the techniques described herein relate to a method including: causing a display to operate in a first mode by driving a plurality of semiconductor emitters using a first current density, the first mode having a first brightness and a first range of colors; and causing the display to operate in a second mode by driving the plurality of semiconductor emitters using a second current density based on a condition associated with ambient light, wherein the second current density is greater than the first current density and causes the display to have a second brightness greater than the first brightness and a second range of colors different than the first range of colors by a shift based on a difference between the second current density and the first current density.

In some aspects, the techniques described herein relate to a display including: a planar array of micro-LEDs; a sensor configured to detect a condition associated with ambient light; and a driver operatively coupled to the planar array of micro-LEDs and the sensor, the driver configured to: cause the display to operate in a first mode by driving the planar array of micro-LEDs using a first current density, the first mode having a first brightness and a first range of colors; and in response to the sensor detecting the condition, cause the display to operate in a second mode by driving the planar array of micro-LEDs using a second current density, the second mode having a second brightness, which is greater than the first brightness, and having a second range of colors that is shifted from the first range of colors.

In some aspects, the techniques described herein relate to a head-worn device including: a display system configured to display virtual content overlaid with a user's view of an environment, the display system including: a plurality of red indium gallium nitride (InGaN) emitters, a plurality of green InGaN emitters, and a plurality of blue InGaN emitters; a sensor configured to detect an ambient light condition; and a driver operatively coupled to the plurality of red, green, and blue InGaN emitters and the sensor, the driver configured to: operate the display system in a first mode by driving the plurality of red, green, and blue InGaN emitters using a first current density, the first mode characterized by a first brightness and a first dominant wavelength; and in response to the sensor detecting the ambient light condition is greater than or equal to a predetermined threshold, operate the display system in a second mode by independently driving the plurality of red InGaN emitters, the plurality of green InGaN emitters, and the plurality of blue InGaN emitters with respective second red, second green, and second blue current densities, the second mode characterized by a second brightness greater than the first brightness and a second dominant wavelength shorter than the first dominant wavelength by a predetermined shift, wherein the predetermined shift is a red predetermined shift corresponding to the plurality of red InGaN emitters, and wherein the red predetermined shift is greater than a green predetermined shift of the plurality of green InGaN emitters and a blue predetermined shift of the plurality of blue InGaN emitters.

In some aspects, the techniques described herein relate to a method for boosting primary color emitters to increase brightness at the expense of adjusting the whitepoint, the method including: defining a white point for a display based on respective first radiant flux from red micro-LEDs, green micro-LEDs, and blue micro-LEDs of the display; driving the red micro-LEDs, the green micro-LEDs, and the blue micro-LEDs with first drive signals to display content at a brightness that is less than a maximum brightness of the white point; detecting an ambient light condition that is greater than or equal to a threshold; and boosting the first drive signals for at least one of the blue micro-LEDs or the green micro-LEDs to produce a second radiant flux that is at least 1.5 times greater than its respective first radiant flux to display a virtual element with a brightness exceeding the maximum brightness of the white point.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 illustrates a user wearing a head-worn device to view virtual content in a bright ambient light condition according to a possible implementation of the present disclosure.

FIG. 2 is a graph illustrating a chromaticity diagram of color vision overlayed by a color gamut of an RGB display according to a possible implementation of the present disclosure.

FIG. 3 illustrates a front view of a display including a plurality of semiconductor emitters according to a possible implementation of the present disclosure.

FIG. 4 is a block diagram of a display system according to a possible implementation of the present disclosure.

FIG. 5 is a graph illustrating an experimental relationship between wavelength and current density for a red semiconductor emitter of a display according to a possible implementation of the present disclosure.

FIG. 6 is a graph illustrating a wavelength shift versus brightness for a red semiconductor emitter of a display according to a possible implementation of the present disclosure.

FIG. 7 is a graph illustrating a gamut ratio for the wavelength shift of FIG. 6 according to a possible implementation of the present disclosure.

FIG. 8 is a graph illustrating shifted color gamuts on a chromaticity diagram of color vision according to a possible implementation of the present disclosure.

FIG. 9 is a display having virtual elements in regions driven in different modes according to a possible implementation of the present disclosure.

FIG. 10 is a display having virtual elements with primary-color emitters driven differently according to a possible implementation of the present disclosure.

FIG. 11 is a top, cutaway view of a head-worn device according to a possible implementation of the present disclosure.

FIG. 12 is a state diagram of a display having a boost mode with shifted colors.

FIG. 13 is a method for boosting primary color emitters to increase brightness of the display.

The components in the drawings are not necessarily to scale relative to each other. Like reference numerals designate corresponding parts throughout the several views.

### DETAILED DESCRIPTION

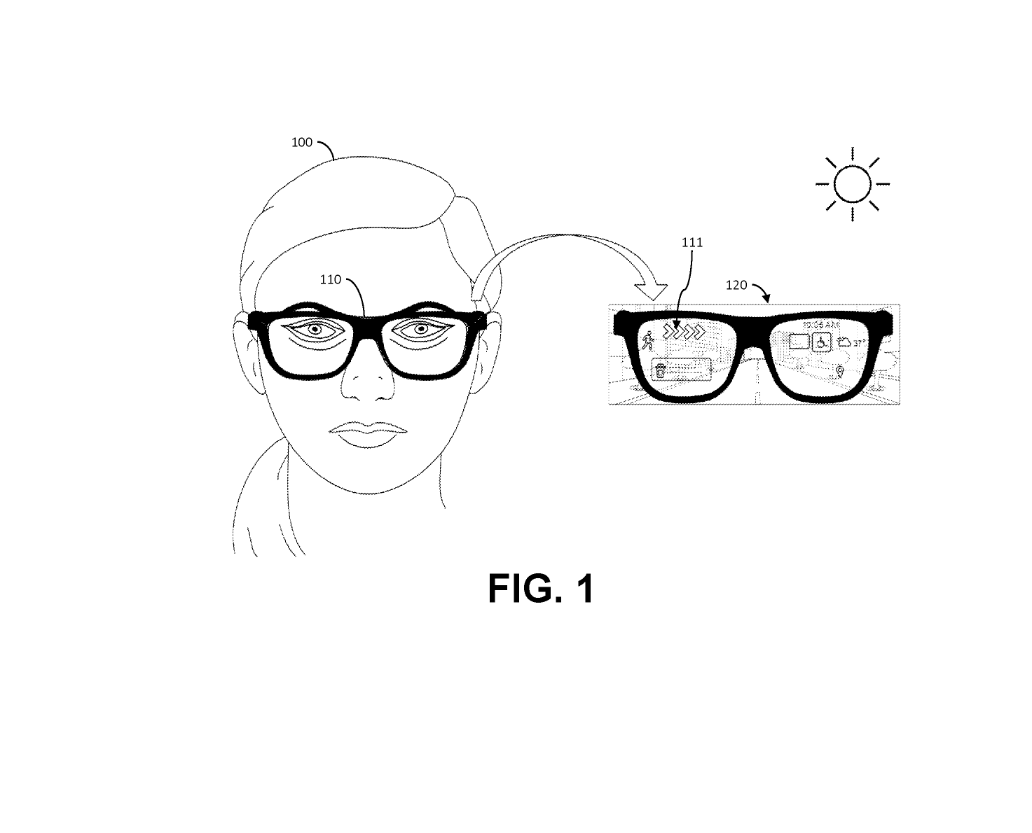

Micro-LED displays can be used in head-worn devices, such as augmented reality (AR) glasses. The brightness of the micro-LED display can be raised to help generate virtual content that is visible in bright ambient light conditions and lowered to prevent eye strain and power consumption in dimmer ambient light conditions. FIG. 1 illustrates a user wearing a head-worn device to view virtual content in a bright ambient light condition according to a possible implementation of the present disclosure. As shown, a user 100 wears a head-worn device 110 in an outdoor environment characterized by a bright ambient light condition. The head-worn device 110 is configured as an augmented reality (AR) system (i.e., AR glasses) configured to display virtual content 111 overlaid onto the user's view of the real-world environment. The virtual content 11, illustrated in a view 120 from the user's perspective, can include various forms of information, such as text, icons and alerts. The display of the head-worn device 110 needs to render the virtual content with a level of brightness that is bright enough to compete with the ambient light of the environment to ensure that the virtual content is legible to the user 100.

A technical problem is the ambient light conditions of the environment may change and adjusting the brightness of the virtual can lead to perceived color changes (i.e. wavelength shifts), especially at the high brightness levels. One reason for this is because a color gamut of a display is linked to the drive current (i.e. current density) provided to the pixels.

The color gamut refers to the complete range of colors that a display can accurately reproduce. This range is determined by the chromaticity of its primary color emitters, typically a red micro-LED, a green micro-LED, and a blue micro-LED. In a standard chromaticity diagram, the color gamut is visualized as a triangular area, with the vertices of the triangle corresponding to the specific coordinates of the three primary colors (i.e., red (R), green (G), and blue (B)). Therefore, if the wavelength of a primary color emitter changes, its corresponding vertex on the chromaticity diagram shifts, altering the size and shape of the color gamut.

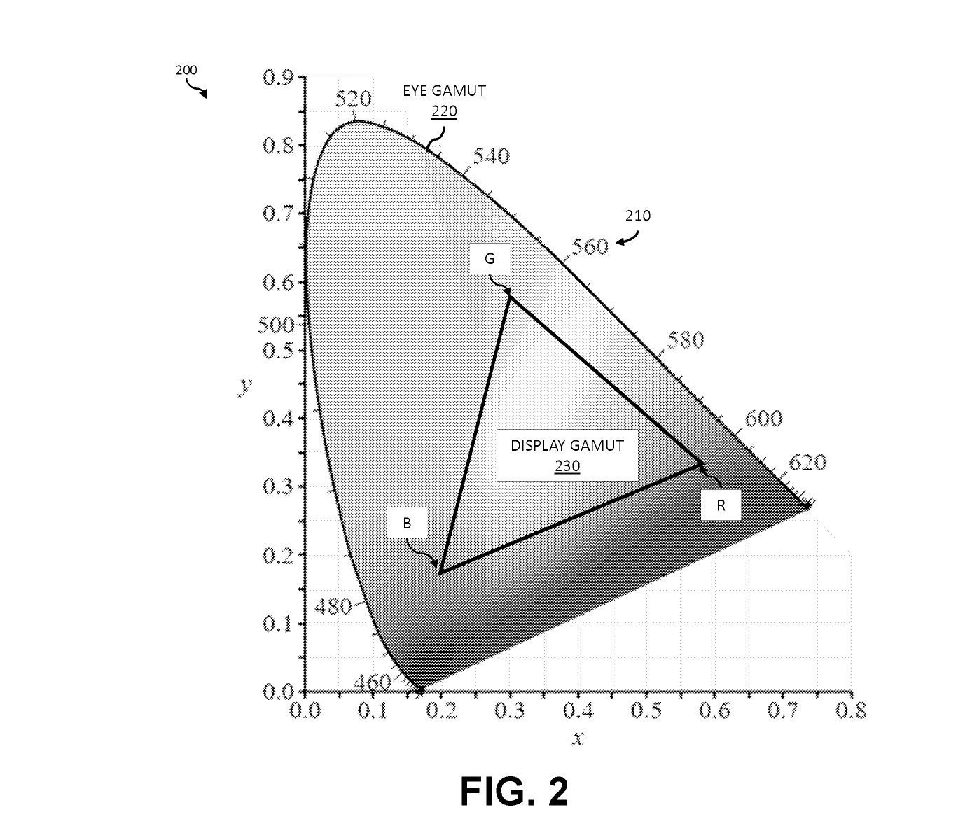

FIG. 2 is a graph illustrating a chromaticity diagram of color vision overlayed by a color gamut of an RGB display according to an implementation of the present disclosure. As shown, visible wavelengths 210, in nanometers (i.e., nm), are plotted on a xy graph 200 corresponding to chromaticity to form a curved boundary having a horseshoe shape. Inside this curved boundary are the colors perceivable by a human (i.e., the eye gamut 220). A display can produce colors based on combinations of its primary points (i.e., R, G, B). As used herein, “primary points” refers to the saturated colors produced by the display’s red micro-LEDs, green micro-LEDs, and blue micro-LED. On the chromaticity diagram, the three primary points form the vertices (i.e., corners) of a triangle that defines the colors that the display can generate (i.e., the display gamut 230). The exact position of each primary point is determined by the dominant wavelength of its corresponding emitter.

A technical problem with micro-LED displays is that the dominant wavelength of one or more of the primary emitters can shift as the brightness of the display is changed (e.g., to accommodate an ambient light condition). In some cases, this wavelength shift (i.e., shift) can create color changes noticeable to a viewer. The shift can result from various physical effects. For example, an increase in the drive current can shift the color of a micro-LED towards a shorter wavelength (i.e., blue shift). One reason for this is that elevated drive current can increase the carrier density in an active region (i.e., quantum well) of the micro-LED. The excess carrier density can fill up the lower energy states within the conduction and valence bands of the active region so that subsequently injected electrons must recombine from higher energy states in the conduction band, resulting in emitted photons having a higher energy. Because this shift is related to the device physics unique to each primary emitter, the wavelength shifts for each color emitter are different. For example, the wavelength shift may be most severe (i.e., largest) for the red micro-LEDs of the display.

The wavelength shift phenomenon is conventionally viewed as a flaw in displays. Accordingly, most conventional displays attempt to mitigate or eliminate the wavelength shift (i.e. color shift) so that the display gamut is fixed for all brightness levels of the display. One traditional approach to preserve color stability is modulating (e.g., pulse-width modulating (PWM)) a fixed drive current for a micro-LED with a variable duty cycle to control its brightness. This approach limits the maximum brightness that micro-LED can generate (i.e., 100% duty cycle), which may not be at a brightness level suitable for very bright environments (e.g., direct sunlight). Another traditional approach is to control the device physics (e.g., channel width) so that the micro-LED does not exhibit a significant wavelength shift as its drive current is changed. This approach may suffer from poor efficiency because micro-LED designs that are most efficient may have the largest wavelength shifts.

In contrast with these traditional approaches, the disclosed display can change the drive current (e.g., by a predetermined boost) in order to provide more brightness and then accommodate the resulting wavelength shift in each color emitter. In other words, the technical approach described here deliberately accepts a change (i.e., shift) in the display gamut as a controlled trade-off for a significant increase in brightness. Accordingly, the proposed approach is a practical and counter-intuitive solution for the display’s visibility in varying ambient light conditions. It is this intentional use of the wavelength shift, which was conventionally considered a flaw, that allows the display to utilize a high-brightness mode (i.e., boost mode) to ensure an adequate brightness so that virtual objects in an AR environment can still be viewed in very bright ambient conditions. One technical effect of this approach is allowing a head-worn device to be used in very bright ambient light conditions while still operating efficiently.

Throughout this disclosure, the term "brightness" is used in a manner consistent with common industry usage, where it is often used interchangeably with the more technically precise term "luminance." Luminance is a photometric measurement that quantifies the amount of light emitted from a particular area in a given direction, and its standard unit is candelas per square meter (cd/m²), commonly referred to as a "nit." In contrast, brightness, in its strictest scientific sense, refers to the subjective perception of luminance by a human observer. Accordingly, unless otherwise specified, references herein to the "brightness" of the display should be understood as referring to its measured luminance.

Similarly, this disclosure refers to "current density" rather than simply "current" when describing the electrical input to the micro-LEDs. Current density is the measure of electrical current flowing through a specific cross-sectional area of the semiconductor, typically expressed in amperes per square centimeter (A/cm²), whereas current is the total electrical flow in amperes (A). For a micro-LED of a given size, these two values are directly proportional. However, current density is the more fundamental physical parameter that dictates the device's optical properties. The wavelength shift phenomenon, for instance, is directly caused by the concentration of charge carriers within the active region, which current density directly quantifies. Therefore, using current density provides a more precise technical description and makes the disclosed principles independent of the physical size of the micro-LED, ensuring that they apply broadly regardless of the specific dimensions of the emitters.

Measuring current density in a micro-LED involves a two-part process that combines direct electrical measurement with the known physical dimensions of the device. The total current (I) supplied to an individual micro-LED can be measured using standard electronic instrumentation. The cross-sectional area (A) through which the current (I) flows is not measured in real-time but is a fixed parameter determined by the semiconductor fabrication process. This area can correspond to the active light-emitting region of the micro-LED, which can be defined by the mesa structure of the p-n junction. Therefore, the current density (J) can be calculated by dividing the measured current by the cross-sectional area (i.e., J = I/A). This calculation provides the precise value needed to generate the predetermined wavelength shift, described herein.

The wavelength shift may be defined as a shift in the dominant wavelength of light emitted by a micro-LED emitter. The distinction between dominant wavelength and peak wavelength is also a technical concept that helps understand the descriptions in this disclosure. The peak wavelength refers to the single wavelength at which a micro-LED’s spectral power distribution reaches its maximum intensity. It is a purely physical measurement of the emission spectrum and does not fully capture the color perceived by a human observer. In contrast, the dominant wavelength is a colorimetric quantity that corresponds to the perceived hue. It is defined on a chromaticity diagram as the wavelength of the pure spectral color that, when additively mixed with a standard white illuminant, produces a color that matches the chromaticity of the micro-LED's emission. Because it accounts for the entire spectral distribution as processed by the human eye, the dominant wavelength provides a more accurate representation of the color of a primary emitter. Therefore, references to wavelength in this document, particularly in the context of color shifts and gamut definition, refer to the dominant wavelength unless otherwise specified, as it is the more relevant metric for display performance.

The disclosure uses the term “radiant flux” to describe the fundamental optical output of the emitters (i.e., micro-LEDs). Radiant flux is a radiometric quantity that measures the total power of electromagnetic radiation (light) emitted per unit time, expressed in watts (W). This is distinct from photometric quantities like luminance, which are weighted by the spectral sensitivity function of the human eye to represent perceived brightness. In the context of this disclosure, radiant flux is used to specify the absolute optical power contribution of each primary emitter (red, green, and blue). By defining properties such as a display's white point in terms of the respective radiant fluxes of its primaries, the display's operation can be described based on the underlying device physics, independent of the nuances of human color perception.

The term “white point” refers to the specific chromaticity of the color white that a display is calibrated to reproduce. It serves as a standard reference for color balance and is typically defined by a set of coordinates on a chromaticity diagram, often corresponding to a standard illuminant, such as D65, which simulates average daylight. In an RGB display, the white point is achieved by additively mixing the light from the red, green, and blue primary emitters at a precisely defined ratio of their respective radiant fluxes. This balance determines the display's color temperature and acts as the neutral reference against which all other colors within the gamut are rendered. The maximum brightness of the display is conventionally defined as the luminance produced when all primaries are driven at the specific levels required to generate this white point.

More specifically, the term “color balance” refers to the adjustment of the relative intensities of the red, green, and blue primaries to ensure that their combination produces a pure, neutral white without any perceptible color cast. This neutral reference is defined by a standard illuminant, which is a theoretical source of light with a precisely specified spectral power distribution that serves as a benchmark for color measurements. A common example is the D65 standard illuminant, which is widely adopted in the display industry to approximate the spectral characteristics of average mid-day daylight. The chromaticity of an illuminant is often characterized by its correlated color temperature, measured in Kelvin (K). “D65” corresponds to a color temperature of approximately 6504 K. A lower color temperature would produce a "warmer" white with a reddish-yellow hue (akin to an incandescent bulb), while a higher color temperature produces a "cooler" white with a bluish hue. By calibrating the white point to a standard like D65, the display ensures color fidelity, rendering all other colors in its gamut relative to this consistent neutral reference

The disclosure describes a display that can be operated in a boost mode to temporarily provide added visibility to virtual content (e.g., text, icons, etc.) in very bright ambient light conditions (i.e., very bright environments). The display can be boosted using two different approaches.

A first approach can boost the overall brightness of the entire display (or a large region of it) by accepting the change in the color gamut that results. The first approach includes increasing the current density equally applied to the red micro-LEDs, the green micro-LEDs, and the blue micro-LEDs (i.e., the subpixels) of the display. By increasing the current density equally for all subpixels, the entire display can get much brighter. The increase may be significant (e.g., 10 times). Increasing the current density causes a wavelength shift of the dominant wavelength emitted by each color. In a possible implementation red has the largest wavelength shift so that the red dominant wavelength of the display becomes more orange. The display in the boost mode trades color accuracy for brightness (i.e., visibility). This tradeoff is likely acceptable for temporary periods.

A second approach can boost the brightness of individual colors (e.g., green, blue) emitters of the display, which can make them appear brighter than the display’s maximum white. The second approach can be used to make specific virtual elements, such as highlighted icons on a user interface (UI), have exceptional brightness compared to the other virtual elements. As discussed, the display’s maximum brightness is defined by the RGB levels of its white point. In the second approach one of the color emitters (e.g., green) is driven at a current density that makes its level greater than its white point level. Thus, while the brightest white is capped, a virtual element can be displayed in the boosted color (e.g., green) so that it can be significantly brighter than a white background. Thus, while the maximum brightness of the display is not changed, one of the primary colors is boosted (i.e., overdriven) over the others.

The first approach boosts the luminance of the entire display area (or significant portion) while the second approach boosts the luminance of specific primary colors. The effect of the first approach is to increase the overall brightness, while shifting the color gamut by a predetermined shift. This can make the entire screen legible in direct sunlight. The effect of the second approach is to increase the radiant flux of one or more colors to a level brighter than its respective level at its white point. This can make a specific icon (e.g., warning) or highlight extraordinarily bright and noticeable.

In some applications, such as augmented reality, a very high display brightness may be required to view virtual content. For instance, 1 meganit (Mnit) or greater may be required. Such a display brightness may translate to a brightness to the eye of a viewer of 1kilonit (knit) or more (e.g., 5knit or more, 10knit or more), which may facilitate viewing outdoors (e.g., use in a bright ambient environment). Conversely, for indoor settings, a moderate brightness to the eye (for instance, in a range 100nits-1knit) may be suitable. Therefore, an AR display may need to function at various brightness levels.

There can be an interaction between a brightness and a color gamut of a display. For example, an indium-gallium-nitride (i.e., InGaN) light emitting diode (LED) of a micro-LED display may undergo a wavelength shift based on the current density (i.e., J) in its active region. The wavelength shift may be observed as a shorter wavelength being emitted from the micro-LED at a higher drive levels. This is especially pronounced for long-wavelength micro-LEDs (e.g., red micro-LEDs). Therefore, varying operating current density can lead to a change in the brightness of a display as well as its color properties, including color gamut and chromaticity of the display’s primary points (primaries). Example display devices described herein make use of this behavior to provide displays with multiple functioning modes that, respectively, have varying brightness and gamut.

A gallium nitride (GaN) based LED may include some of the following elements: a substrate (such as sapphire, silicon), a GaN template formed on the substrate, a n-doped region, an InGaN-based preparation layer (or underlayer) to improve the material quality, an active region including a plurality of InGaN-containing quantum wells separated by barriers, an electron blocking layer, a p-doped region. The LED may include layers of GaN, InGaN, AlGaN, AlInGaN, which can be n-doped, undoped, p-doped. Besides GaN-based LEDs, other semiconductors can be envisioned (including GaAs, AlInGaAsP).

The micro-LEDs of a display device can be inorganic semiconductor emitters that produce different colors of light. A color pixel of a micro-LED may include three different color subpixels which can be driven at different levels so that they combine to form the color of the color pixel. The subpixels are integrated on the same surface (i.e., planar) of the same substrate (i.e., monolithic).

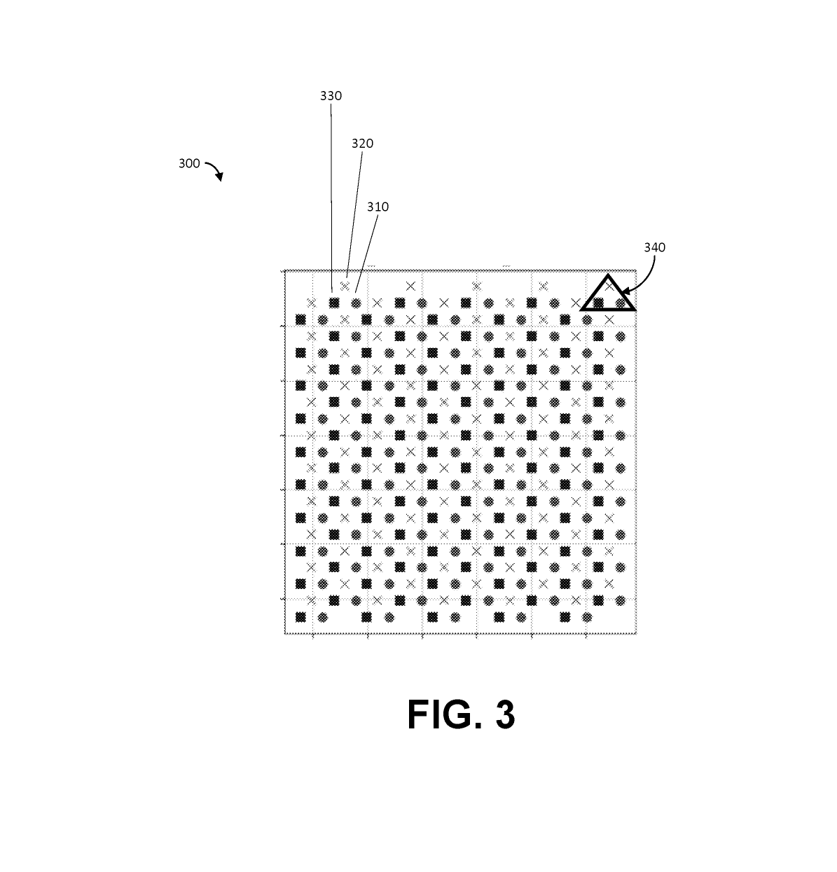

FIG. 3 illustrates a front view of a display including a plurality of semiconductor emitters according to a possible implementation of the present disclosure. As shown, the display 300 includes a planar array of microscopic light-emitting diodes (micro-LEDs) monolithically integrated on a single substrate. The array is composed of individual primary color emitters, including a plurality of red emitters 310, a plurality of green emitters 320, and a plurality of blue emitters 330. In some implementations, all three types of emitters are fabricated from indium gallium nitride (i.e., InGaN) based materials, with the specific composition of the active region tuned to produce the desired red, green, or blue light. The individual color emitters can be grouped logically to form subpixels of a color pixel 340. For example, a color pixel 340 may include a red subpixel, a green subpixel, and a blue subpixel. The subpixels are arranged in a repeating pattern in the plane of the display. By independently controlling the current supplied to each red, green, and blue subpixel within a color pixel 340, the display can generate a wide spectrum of colors for each color pixel 340. The subpixels are on a surface (e.g., front surface of the substrate so that they are planar. Each subpixel (i.e. primary color emitter, micro-LED) can have a dimension and pitch that is less than 10 micrometers.

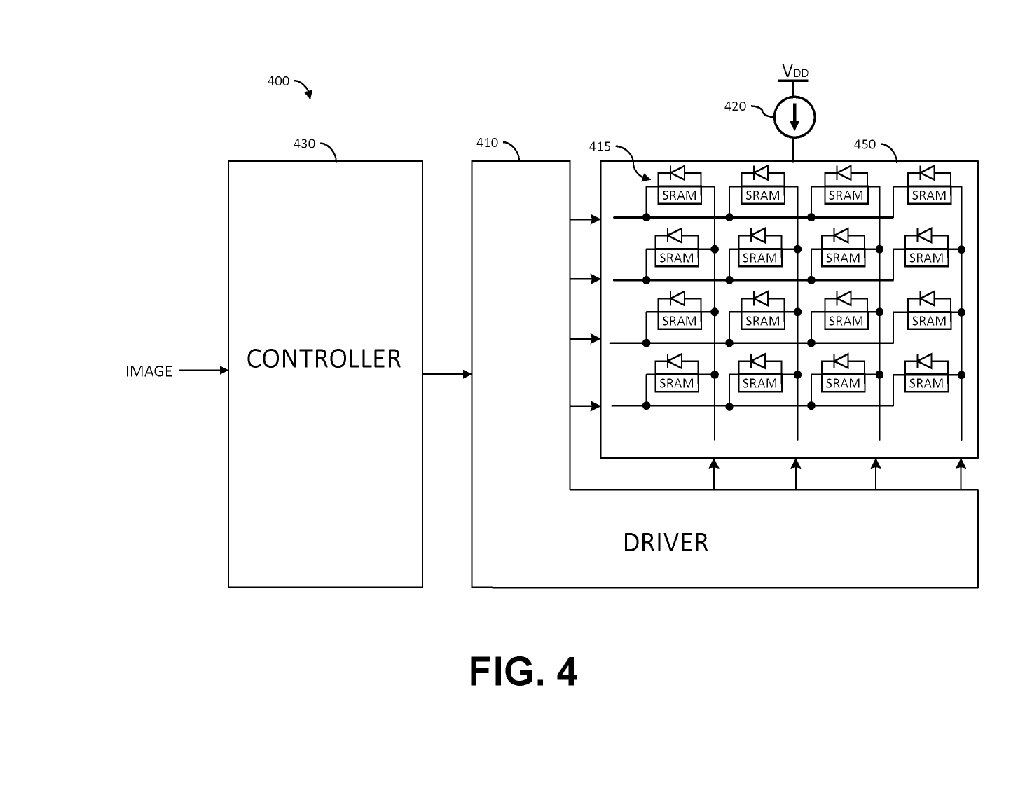

FIG. 4 is a block diagram of a display system according to a possible implementation of the present disclosure. FIG. 4 is a block diagram of a display system according to a possible implementation of the present disclosure. The display system 400 includes a controller 430, a driver 410, a plurality of pixels (i.e. pixel array 450), and a current source 420. In operation, the controller 430 receives and processes image data, then provides control signals to the driver 410. The driver 410, in turn, generates the appropriate drive signals to address and illuminate each micro-LED 415 within the pixel array 450 during a frame to form an image. The pixel array 450 is an active matrix array where each subpixel is individually controlled.

The current source 420 is operatively coupled to the pixel array 450 and provides the drive current for the micro-LEDs. The current supplied by the source 420 can be adjusted, for example, under the control of the controller 430. By adjusting the output of the current source 420, the driver 410 can change the current density supplied to the micro-LEDs of the pixel array 450. This mechanism allows the display system 400 to switch between different modes of operation, such as transitioning from a first mode with a first current density to a second, high-brightness "boost mode" with a second, higher current density (e.g., in response to an ambient light condition).

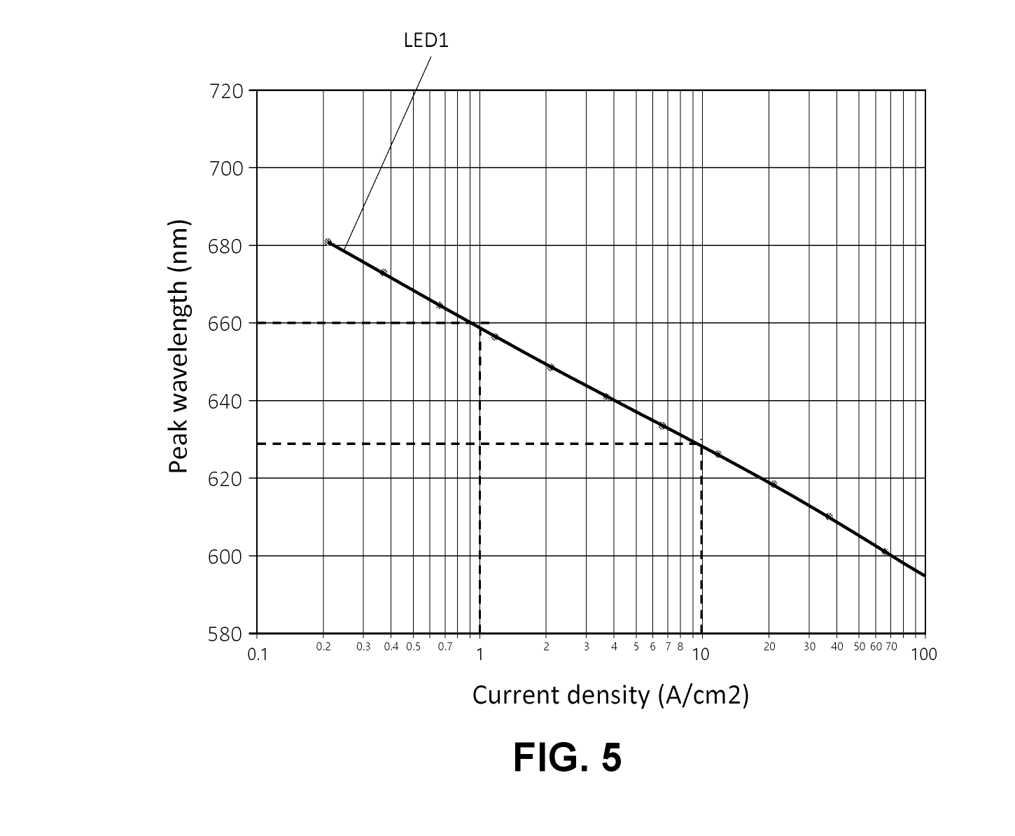

FIG. 5 is a graph illustrating an experimental relationship between wavelength and current density for a red semiconductor emitter of a display according to a possible implementation of the present disclosure. The graph illustrates a relationship between peak wavelength (λp), measured in nanometers (nm) and current density, measured in amps/square-centimeters (A/cm²) for a red semiconductor emitter (i.e., InGaN micro-LED) of a display. As shown, the peak wavelength (λp) monotonically decreases with increasing current density. For example, when J=1A/cm² then λp =660nm and when J=10A/cm² then λp =630nm. In other words, a 10 times increase in current density provides a wavelength shift of 30nm. This wavelength shift can be predetermined based on simulation and empirical measurement because the specific value of the wavelength shift depends, at least in part, on the LED design. In this example, the wavelength shift of the red micro-LED is about 30nm per decade of current density. In other examples, the shift can be at least 20nm/decade.

Likewise, green InGaN-based LEDs can also display a wavelength shift that shifts to shorter wavelengths (i.e. blue shifts) with current density. In some examples, the wavelength shift of the green micro-LEDs can be 15nm/decade, 10nm/decade, or 5nm/decade. Blue InGaN micro-LEDs often display a small wavelength shift with current density. In some examples, the wavelength shift of the blue micro-LEDs is at least 2nm/decade, or 1nm/decade.

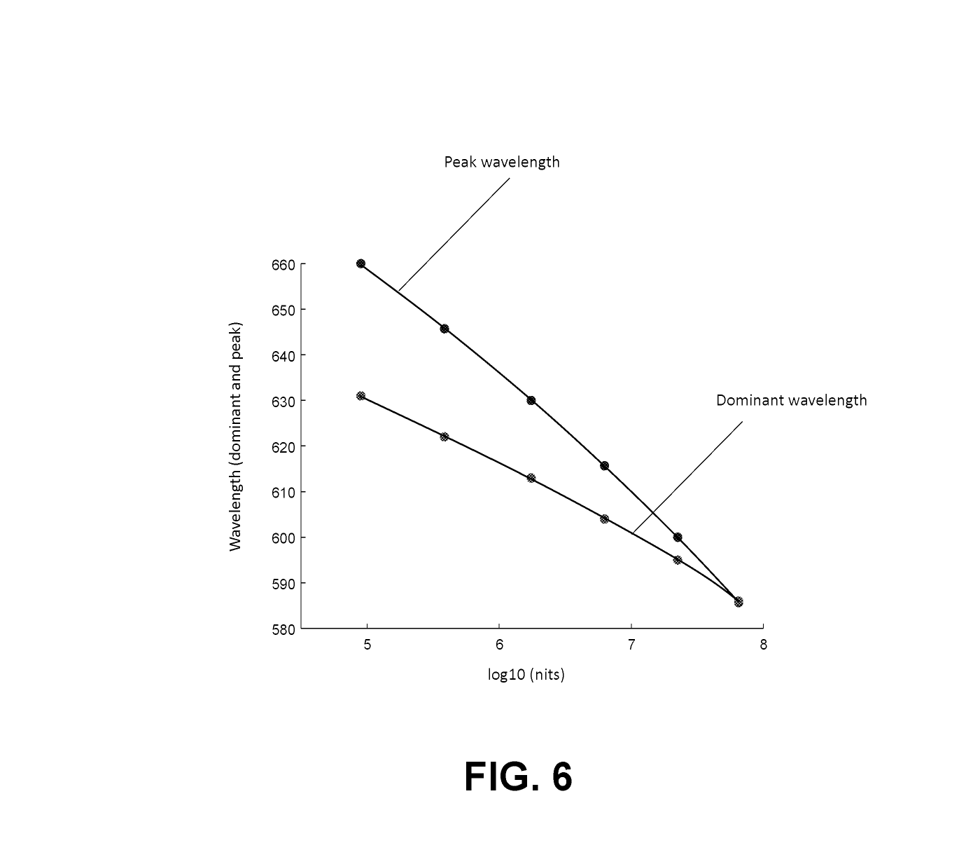

FIG. 6 is a graph illustrating a wavelength shift versus brightness for a red semiconductor emitter of a display according to a possible implementation of the present disclosure. In this example, the brightness of micro-LEDs (having wavelength shifts as described above) is measured as the current density of the driving condition (for all three colors) is adjusted in a range from 1A/cm² to 300A/cm². The brightness spans about 100 knits to 60 Mnits over this driving condition range. Next the peak wavelength and the dominant wavelengths for the range of brightness is shown. As shown, as the brightness increases, the peak wavelength decreases from 660nm to 585nm, and the dominant wavelength decreases from 630nm to 585nm. In view of the measurable relationships illustrated in FIGS. 5 and 6, a driving condition of a display can be boosted from a first current density to a second current density to produce predetermined shifts in the wavelengths emitted by the primary color emitters. In other words, driving a red micro-LED with a second current density is greater than a first current density causes a display to have a second brightness greater than a first brightness and a second dominant wavelength that is shorter than the first dominant wavelength by a predetermined shift based on a difference between the second current density and the first current density.

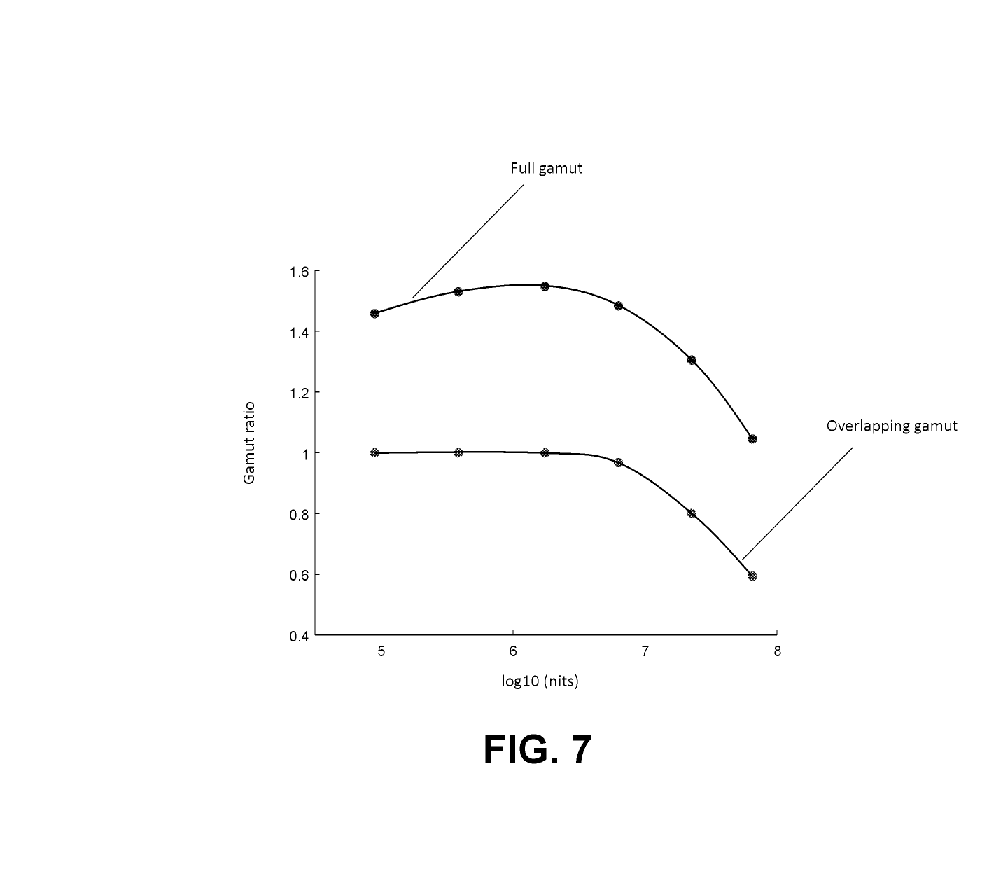

FIG. 7 is a graph illustrating a gamut ratio for the wavelength shift of FIG. 6 according to a possible implementation of the present disclosure. The term “gamut ratio” corresponds to a quantitative measure of a display's color reproduction capability relative to a standard reference gamut, such as sRGB, which is a display gamut widely used for consumer products and internet content. The gamut ratio can be calculated as the ratio of the area of the display's gamut to the area of the reference gamut (e.g., sRGB gamut) when both are plotted on a chromaticity diagram. The display gamut can be evaluated in two ways: as a "full gamut ratio" or an "overlapping gamut ratio." The full gamut ratio compares the total area of the display's gamut triangle to the reference gamut, which can result in a value greater than 100% if the display can produce colors outside the standard. Conversely, the overlapping gamut ratio measures only the portion of the display's gamut that falls within the reference gamut, quantifying how well the display covers the standard color space. This value cannot exceed 100% and is particularly useful for characterizing the effective loss of color coverage when a phenomenon like wavelength shift causes the display's gamut to move. As shown in FIG. 7, the full gamut area first slightly increases with brightness, then decreases. The overlapping gamut area is one for a brightness up to 1.5Mnit, then decreases for a higher brightness. Accordingly, a micro-LED display can be configured to emit a brightness with a predetermined effect on the gamut ratio. It should be noted that while sRGB gamut is a common reference gamut, other reference gamuts (DCI-P3, Rec2020) can be used as well.

A display can be operated in two modes. A display can be operated in a first mode by driving a plurality of semiconductor emitters using a first current density. The first mode is characterized by a first input power, current density, brightness, primary wavelengths, and display gamut (i.e., color gamut). A display can also be operated in a second mode by driving the semiconductor emitter using a second current density. The second mode is characterized by a second input power, current density, brightness, wavelength, color gamut. When the second input power, current density, and brightness are higher, the second wavelength is shorter (e.g., smaller) and a second gamut ratio may be smaller than a first gamut ratio.

In a possible implementation the first mode corresponds to an indoor ambient light condition, while the second mode corresponds to an outdoor ambient light condition. For example, the first mode can have a brightness less than 2Mnit (e.g., 1Mnit, 500knits, or 100knits), and a red dominant wavelength of at least 600nm (e.g., 605nm, 610nm, 620nm, or 630nm). The second mode can have a brightness higher than 1Mnit (e.g., 1.5Mnit, 2Mnit or 5Mnit), and a red dominant wavelength less than 610nm (e.g., 600nm or 590nm).

In a specific example, a display in a first mode (relatively low brightness and high gamut) has primaries with the following dominant wavelengths: (464nm, 525nm, 608nm). The display achieves a gamut of 100% sRGB (i.e. it fully covers the sRGB reference gamut). The display can also operate in a second mode (relatively high brightness, low gamut) where the primaries have the following dominant wavelengths: (464nm, 525nm, 600nm). In the second mode, the red emitters are driven at double the current density of the first mode, enabling double the brightness (for instance, the peak brightness for white increases from 1Mnit to 2Mnit). The display achieves a gamut of about 80% sRGB – a decrease caused by the red wavelength shift.

In some examples, a display operates in a first mode where its coverage of a reference gamut (calculated in u’v’ space) is at least 85% (or 90%, 95%, 100%). The display operates in a second mode where its coverage of the reference gamut is reduced by at last 5% (or at least 10%), and its brightness is increased by at least 20% (or at least 50%), compared to the first mode. The reference gamut may be sRGB, or DCI-P3, or Rec2020.

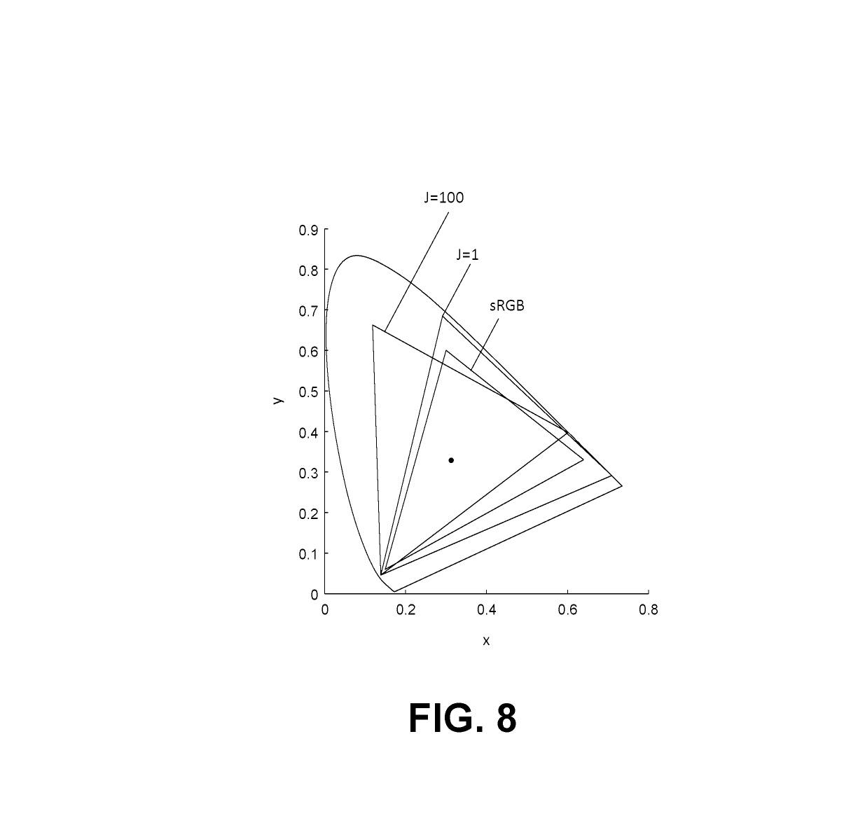

FIG. 8 is a graph illustrating shifted gamuts (relative to a reference gamut) on a chromaticity diagram of color vision according to a possible implementation of the present disclosure. A first display gamut (i.e., J=1) is shown relative to a reference gamut (i.e., sRGB). The first display gamut corresponds to a display with micro-LEDs driven at J=1A/cm². As shown the first display gamut (i.e., J=1) extends around the reference gamut (i.e., sRBG). The blue primary of the first display gamut is relatively unchanged from the blue primary of the reference gamut. A second display gamut (i.e., J=100) is also shown relative to the reference gamut (i.e., sRGB). The second display gamut corresponds to the display with the micro-LEDs driven at 100A/cm². As shown, the second display gamut (J=100) has its green primary and its red primaries are shifted (i.e., blue shifted) from the green and red primaries of the reference gamut (i.e., sRGB).

As the current density is increased, the shifted gamut may become smaller than the reference (i.e., target) gamut. In this case, the colors of the primaries may appear (to a viewer) different from the expected (i.e., target) red, green, blue. For example, light from a green primary emitter may appear cyan, and light from the red primary emitter may appear orange (or yellow). In some such examples, the display may be used to display a restricted set of colors, or even just a single color, e.g., just white

The virtual content may be changed in the boost mode. For example, due to the shifted gamut, the virtual content may be displayed with a different color. In a possible implementation, the different color may be a from a reduced set of colors, such as from the area of the shifted gamut (e.g., J=100) that overlaps (i.e., intersects) with the reference gamut (e.g., sRGB). In another possible implementation, the different color may be a single color (e.g., white). In other words, in a first mode (i.e., non-boost mode, normal mode) corresponding to an ambient light condition being below a threshold, the virtual content may be displayed in full color, while in the second mode (i.e., boost mode, bright mode), the virtual content may be displayed in reduced (or single) color to compensate for the shifted gamut.

In a possible implementation, the change between modes includes changing the current supplied to the subpixels. This supplied current is the maximum current level that each subpixel can receive. Gray levels can still be applied to the subpixels by modulating this maximum current level using either amplitude modulation or pulse-width modulation.

In some examples, a display can be switched between the first mode and the second mode based on an ambient light condition. The ambient light condition may be detected in a variety of ways. In a possible implementation an ambient light condition (i.e., light level) may be detected by a light sensor (i.e., sensor). In this case, the mode shift decision may be based on the ambient light condition satisfying a criterion, such as a comparison to a predetermined threshold (i.e., dim/bright threshold, indoor/outdoor threshold). For example, the display may be operated in the first mode when the ambient light condition is less than the predetermined threshold, and the display may be operated in the second mode when the ambient light condition is greater than or equal to the predetermined threshold.

Various heuristic rules for switching modes may be used in addition to, or in place of, the ambient light condition. For example, the display may be configured in a mode based on a time and/or a location. For example, the display can be configured to operate in the first mode at a time that is after the sunset (i.e. after dark). In some examples, the display can be configured to operate in the first mode or the second mode based on a location. For example, the display can be configured to operate in the first mode when the location is an indoor location and operating in the second mode when the location is an outdoor location (e.g., the beach).

In some examples, a display can be subdivided into at least two regions, each operating in the first mode or second mode. A first region can operate in the first mode and a second region can operate in the second mode. This can be achieved through the use of a display driver (e.g., a CMOS driving a micro-LED display) that is capable of driving various regions at different currents (i.e., different maximum current levels). The first region can be used to display images with more saturated colors (e.g., saturated red). The second region can be used to display a bright indicator that is visible even in a bright environment, with less saturated colors (e.g., the red primary may be orange or yellow). The first and second regions may correspond to separate portions of a viewer’s field of view.

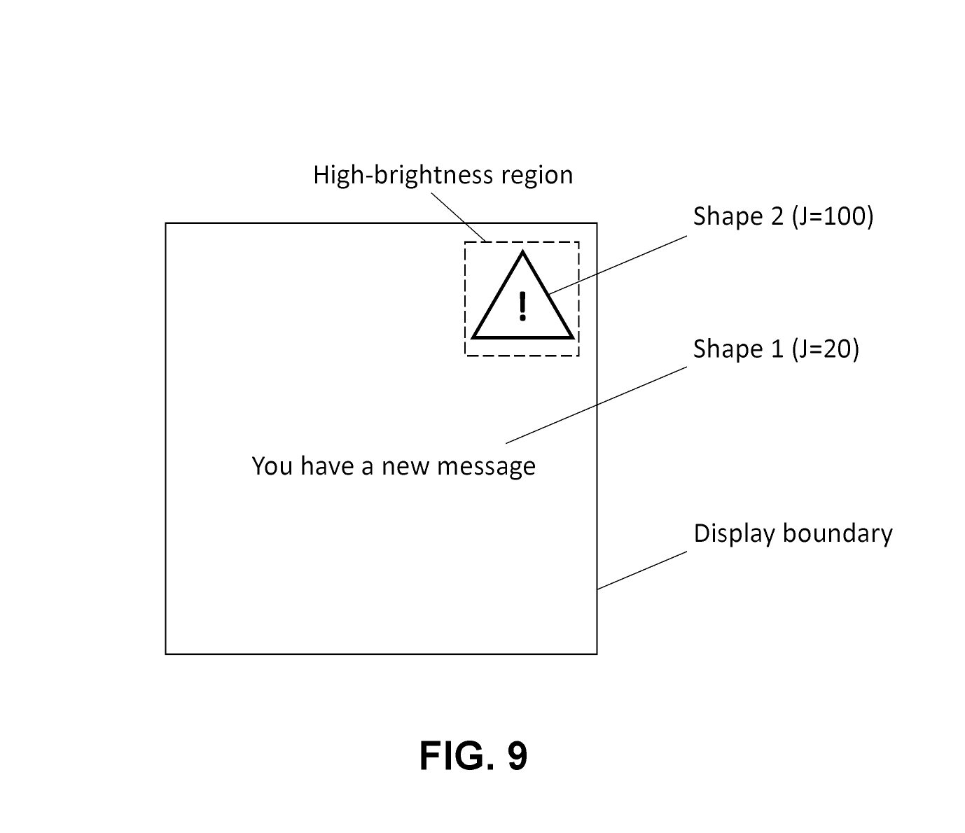

FIG. 9 is a display having virtual elements in regions driven in different modes according to a possible implementation of the present disclosure. As shown, the display has a first region (i.e., main region) with a standard brightness (i.e., operating in the first mode). For example, the standard brightness (i.e., first mode) may correspond to the red primary subpixels in this area receiving J=20A/cm². As shown, a text message is displayed in the first region (J=20). The display also has a second region (i.e., alert region) with a high brightness (i.e. boosted mode). For example, the high brightness (i.e., first mode) may correspond to the red primary subpixels in this area receiving J=100A/cm². As shown, an alert (i.e., warning icon) can be displayed in the second region (J=100). The high brightness of the second region can lend a sense of urgency and importance to the alert and can make the alert visible in all environments.

As mentioned, the second approach can boost the brightness of individual colors (e.g., green, blue) emitters of the display. Accordingly, this approach may be referred to as primary boosting. The display typically has three primary colors (i.e., red, green, blue) driven at respective maximum current levels (i.e., Ir, Ig, Ib). Accordingly, each primary color emitter is capable of a maximum photometric flux (i.e., Fr, Fg, Fb) when driven at the maximum current level.

Conventionally, the display’s white point (e.g., D65 white) corresponds to the color displayed when all primary color emitters are operated at their maximum flux (i.e., Fr+Fg+Fb). In other words, a display may encode images as follows: white (1,1,1), primary red (1,0,0), primary green (0,1,0), primary blue (0,0,1). In this case, “1” denotes the maximum (Fb, Fg, Fr) of the respective primary emitter. Note that, after digitization, the value of 1 is converted to an integer value. For instance, in an example of an 8-bit image, 1 is given the bit value 255 (e.g., the white point has a value of (255, 255, 255)).

In primary boosting, at least one primary color emitter is capable of being driven to a flux that is higher than necessary for the white point (e.g., F > Fg). For instance, the brightest white point is achieved at a setpoint of (1,1,1), and the red primary’s maximum setpoint is 1, but the green and blue primaries are capable of being driven at a setpoint 2. In this case, the red primary caps the maximum brightness at D65. However, for colors that are closer to the green and/or blue primaries, the brightness may be further increased. For instance, a green-primary pixel may be driven at (0,2,0). This doubles the luminance of this pixel in comparison to what would be achievable in prior implementations. A brightest emission from the display in this example corresponds to a setpoint (2,2,1). This may be used to display very bright pixels in a region of a display.

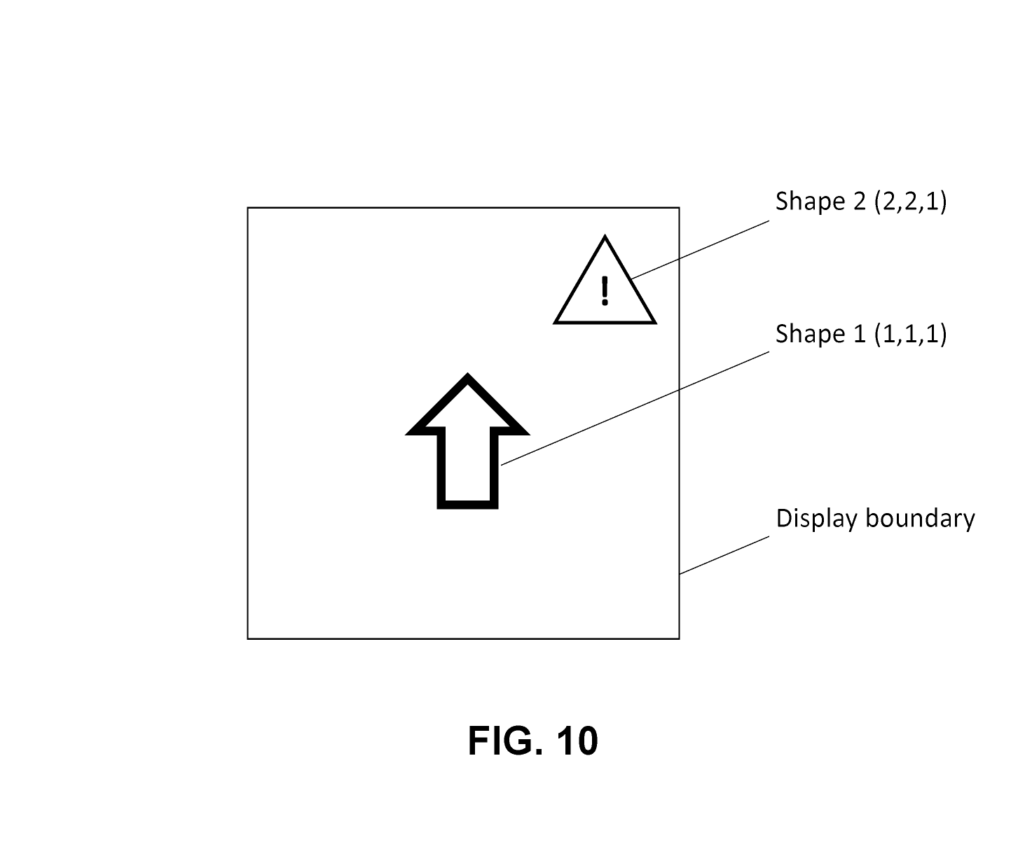

FIG. 10 is a display having virtual elements with primary-color emitters driven differently according to a possible implementation of the present disclosure. As shown, the display is configured to render a first shape (i.e., shape 1) encoded according to the normal white point (i.e., 1, 1, 1). The display is further configured to render (at the same time) a second shape (i.e., shape 2) encoded to a different white point (i.e., 1, 2, 2), in which the radiant flux of the green subpixels and the blue subpixels for this shape are overdriven to a higher flux so that the second shape is brighter than the first shape. As shown , boosted primary may be applied to particular virtual content, such as a warning. As shown the second shape is a warning icon.

In terms of bit-encoded values, in an 8-bit scheme, the white point may be given the value (127, 127, 127). The red primary can only be driven at (127, 0,0); the blue primary can be driven at (0,0,255); the green primary can be driven at (0,255,0). A higher bit depth may also be used. For instance, an extra bit may be used, such that white still corresponds to (255,255,255) but green can be driven to (0,511,0).

In some implementations, a display can have a white point encoded by RGB brightness levels (Fr, Fg, Fb). At least one of the primaries (e.g., the green primary) is capable of being driven at a brightness level of at least 1.2 times Fg (or 1.5 times, 2 times Fg).

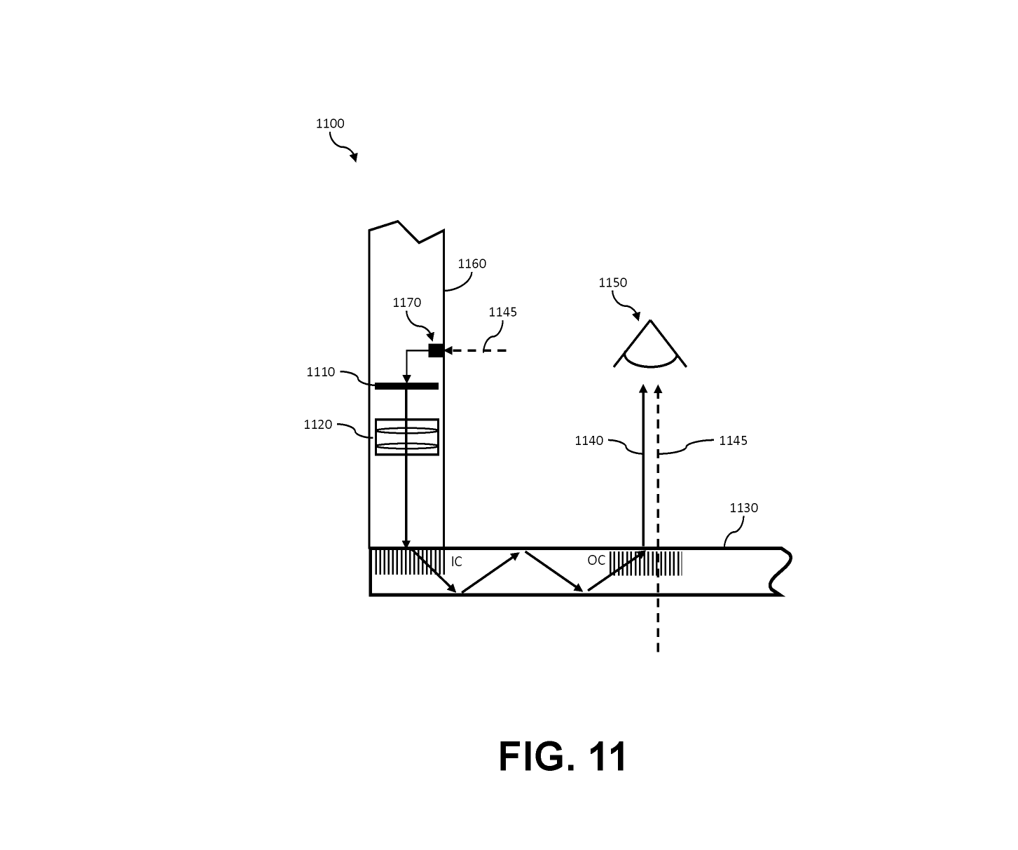

FIG. 11 is a top, cutaway view of a head-worn device 1100 according to a possible implementation of the present disclosure. As shown, the head-worn device 1100 includes a display system configured to project light generated by a display 1110 through a lens system 1120 and toward a waveguide 1130. An input coupler (IC), which can be implemented as a grating, is configured to couple the incident light into the waveguide 1130. The light is then guided within the waveguide until it reaches an output coupler (OC). The output coupler, which can also be a grating, couples the display light 1140 out of the waveguide and directs it toward an eye 1150 of the user, thereby presenting the virtual content.

The head-worn device 1100 can be implemented as AR glasses with the display 1110 integrated into a temple arm 1160 and the waveguide integrated with a lens. Accordingly, the display light 1140 reaches the eye 1150 along with ambient light 1145 from the environment. The head-worn device 1100 may further include a sensor 1170 configured to receive ambient light 1145 to detect an ambient light condition, which can be used to control a mode (e.g., boost mode) of the display 1110.

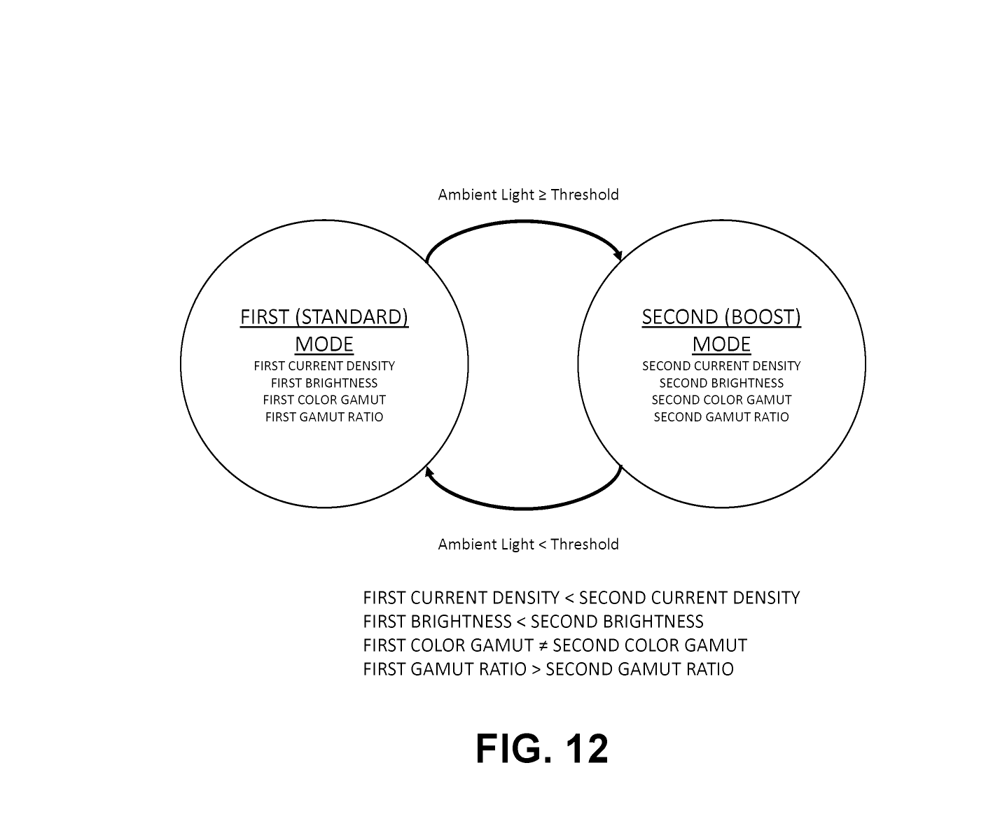

FIG. 12 is a state diagram of a display having a boost mode with shifted colors. The diagram illustrates the operational states (i.e., modes) for a display that can switch between two distinct modes based on environmental factors. In a possible implementation, the system defaults to a "First (Standard) Mode," which is characterized by operation with a first current density (e.g., relatively low current density) that produces a first brightness (i.e., relatively low current density) and a first color gamut (e.g., approximately sRGB). The first mode is optimized for standard viewing conditions where color accuracy is prioritized. In response to a specific trigger, the system can transition to a "Second (Boost) Mode," which uses a second, higher current density to produce a second, greater brightness and a second, different color gamut, ensuring visibility in challenging lighting conditions.

The transition between these two modes is controlled by a condition associated with ambient light, as detected by a sensor. When the ambient light level is greater than or equal to a predetermined threshold, the display system switches from the first mode to the second (boost) mode. Conversely, when the ambient light level drops below the threshold, the system reverts to the first mode. As indicated in the diagram, the second current density is greater than the first current density, which causes the second brightness to be greater than the first brightness. This change in current density is also the basis for the controlled shift in the range of colors (i.e., color gamut), resulting in a second color gamut that is different from the first color gamut.

This state-based control represents a deliberate trade-off between brightness and color fidelity. As shown, the gamut ratio in the second mode is lower than in the first mode, indicating that the significant increase in brightness comes at the expense of a potentially smaller range of reproducible colors relative to a reference standard. This intentional shift allows the display, which may be a monolithic micro-LED display comprising red, green, and blue InGaN emitters, to remain legible in bright sunlight. To manage this change, the system can map the colors of virtual content from the first color gamut to the second, for instance by reducing color saturation or rendering the content monochromatically, thereby ensuring that the content remains visible and clear to the user.

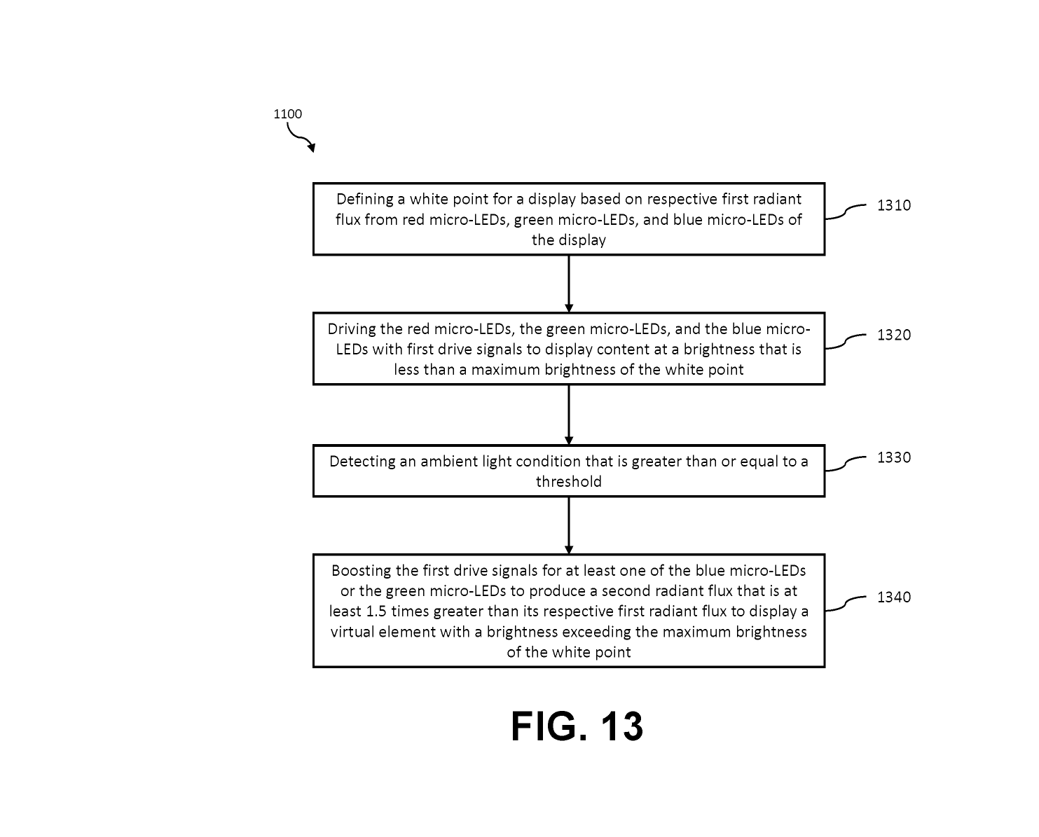

FIG. 13 is a method for boosting primary color emitters to increase brightness of the display. The method 1300 for selectively boosting the brightness of specific primary colors is consistent with the second approach described previously. At step 1310, a white point is defined for the display based on the respective first radiant fluxes from its red, green, and blue micro-LEDs. This white point establishes the maximum brightness for white content on the display. At step 1320, the display operates under normal conditions, driving the micro-LEDs with first drive signals to display content at a brightness below this maximum. The process includes a trigger condition at step 1330, where an ambient light condition is detected to be greater than or equal to a threshold, indicating a bright environment. In response, at step 1340, the system boosts the drive signals for at least one of the blue or green micro-LEDs to produce a second radiant flux that is substantially greater (e.g., at least 1.5 times) than its respective first radiant flux. This allows a specific virtual element to be displayed with a brightness that exceeds the maximum brightness of the display's defined white point.

This method 1300 for primary boosting allows for a different approach to enhancing visibility in bright conditions. Unlike the first approach, which increases the brightness of the entire display at the cost of shifting the color gamut, this technique targets individual primary emitters. By overdriving the green and/or blue micro-LEDs, specific virtual content, such as a warning icon or a user interface highlight, can be made to appear exceptionally bright (e.g., brighter than content rendered as maximum white). This targeted boost ensures that critical information (i.e., particular virtual content) can effectively capture the user's attention without requiring the entire display to operate at a higher power level, thereby providing a power-efficient solution for emphasizing specific virtual elements in a high-ambient-light environment.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

1. A method comprising:
causing a display to operate in a first mode by driving a plurality of semiconductor emitters using a first current density, the first mode having a first brightness and a first range of colors; and
causing the display to operate in a second mode by driving the plurality of semiconductor emitters using a second current density based on a condition associated with ambient light,
wherein the second current density is greater than the first current density and causes the display to have a second brightness greater than the first brightness and a second range of colors different than the first range of colors by a shift based on a difference between the second current density and the first current density.

2. The method according to claim 1, wherein the first current density and the second current density are not based on a duty cycle of a pulse width modulation signal.

3. The method according to claim 1 wherein the second brightness is at least 1.5 times the first brightness.

4. The method according to claim 1, wherein the shift changes a dominant wavelength by a red semiconductor emitter at least 5 nanometers.

5. The method according to claim 1, wherein the plurality of semiconductor emitters includes a plurality of red indium gallium nitride (InGaN) emitters.

6. The method according to claim 1, wherein the first range of colors is a first color gamut that corresponds to a reference color gamut, and the second range of colors is a second color gamut that has been a shifted and resized relative to the reference color gamut.

7. The method according to claim 6, wherein a first area of overlap between the second color gamut and the reference color gamut is smaller than a second area of overlap between the first color gamut and the reference color gamut.

8. The method according to claim 6, further comprises mapping the colors of virtual content from the first color gamut to the second color gamut while operating in the second mode.

9. The method according to claim 8, wherein the mapping reduces a color saturation of the colors of the virtual content.

10. The method according to claim 8, wherein the mapping makes the virtual content appear monochromatic.

11. The method according to claim 1, wherein in the second mode, a red dominant wavelength of a red primary emitter of the plurality of semiconductor emitters is shifted more than a green dominant wavelength of a green primary emitter and is shifted more than a blue dominant wavelength of a blue primary emitter.

12. The method according to claim 1, wherein the first brightness is a maximum brightness of the display when the plurality of semiconductor emitters are driven to produce a white point corresponding to a D65 standard.

13. The method according to claim 1 wherein the display is a monolithic micro-LED display.

14. A display comprising:
a planar array of micro-LEDs;
a sensor configured to detect a condition associated with ambient light; and
a driver operatively coupled to the planar array of micro-LEDs and the sensor, the driver configured to:
cause the display to operate in a first mode by driving the planar array of micro-LEDs using a first current density, the first mode having a first brightness and a first range of colors; and
in response to the sensor detecting the condition, cause the display to operate in a second mode by driving the planar array of micro-LEDs using a second current density, the second mode having a second brightness, which is greater than the first brightness, and having a second range of colors that is shifted from the first range of colors.

15. The display according to claim 14, wherein the planar array of micro-LED includes a plurality of red indium gallium nitride (InGaN) emitters, a plurality of green InGaN emitters, and a plurality of blue InGaN emitters.

16. The display according to claim 15, wherein driving the planar array of micro-LEDs using the second current density includes independently driving the plurality of red InGaN emitters, the plurality of green InGaN emitters, and the plurality of blue InGaN emitters with respective second red, second green, and second blue current densities.

17. The display according to claim 15, wherein:
the second range of colors is shifted based on a first wavelength shift of the plurality of red InGaN emitters, a second wavelength shift of the plurality of green InGaN emitters, and a third wavelength shift of the plurality of blue InGaN emitters; and
the first wavelength shift is greater than the second wavelength shift and the third wavelength shift.

18. The display according to claim 17, wherein the first wavelength shift is a blue shift of at least 5 nanometers.

19. The display according to claim 14, wherein the driver is further configured to operate a first region of the planar array of micro-LEDs in the first mode while simultaneously operating a second region of the planar array of micro-LEDs in the second mode.

20. The display according to claim 19, wherein:
the display is part of a head-worn device configured to display virtual content overlaid with a user’s view of an environment; and
the second region is configured to display virtual content corresponding to an alert.
